(19) United States
(12) Patent Application Publication
(10) Pub. No.: US 2023/0394184 A1
(43) Pub. Date: Dec. 7, 2023

(54) METHOD AND SYSTEM FOR SCATTERING GEOMETRIC COMPONENTS IN A THREE-DIMENSIONAL SPACE

(71) Applicant: Siemens Industry Software Inc., Plano, TX (US)

(72) Inventor: Shantanu Pagar, Pune (IN)

(21) Appl. No.: 17/833,424

(22) Filed: Jun. 6, 2022

(51) Int. Cl. G06F 30/12

(52) U.S. Cl. CPC G06F 30/12; G06F 2111/20

(57) ABSTRACT

A method and system for scattering geometric components in a three-dimensional space are disclosed. A method includes determining geometric components needed for assembling a CAD model of a product, and determining a scatter plane for scattering the geometric components in the three-dimensional space in the CAD environment. The method includes computing a two-dimensional projection of the geometric components. The method also includes determining a position of each of the geometric components based on the two-dimensional projection of the geometric components. The method includes placing each of the geometric components in the scatter plane based on the position of said each geometric component.

### FIELD OF TECHNOLOGY

The present disclosure relates to the field of computer-aided design of products, and more particularly, relates to a method and system for scattering geometric components in a three-dimensional space.

### BACKGROUND

Computer-aided design (CAD) is the use of a computer system to assist a user in creation, modification, and analysis of complex three-dimensional (3D) geometric models generally outputted as electronic files for print, machining, or other manufacturing operations. Typically, a design engineer may use CAD software loaded on the computer system to construct a 3D geometric model of a real-world object (e.g., a product). For example, the design engineer may create various geometric components of a real-world object using the CAD software and assemble the geometric components into one or more subassemblies. Then, the design engineer may assemble the one or more subassemblies to form a 3D geometric model of the real-world object.

Typically, the real-world object may include components ranging from hundreds to hundreds of thousands. Therefore, prior to assembling the geometric components into the CAD assembly, the geometric components are scattered in a three-dimensional space. Currently known CAD software provide scattering of the geometric components. The CAD software scatters the geometric components in a radial pattern using bounding box radius. The CAD software considers a largest bounding box radius computed based on large size geometric components for scattering a set of geometric components of different sizes (small to large). This may result in higher usage of the three-dimensional space for scattering a large number of components of different sizes. Also, the CAD software scatters the geometric components on a principal plane, resulting in overlapping of the geometric components. This may cause inconvenience to the design engineer during selecting the scattered geometric components for creating the CAD assembly.

### SUMMARY AND DESCRIPTION

A method and system for scattering geometric components in a three-dimensional space is disclosed. In one aspect, a method includes determining geometric components needed for assembling a Computer-Aided Design (CAD) model of a product, determining a scatter plane for scattering the geometric components in the three-dimensional space in the CAD environment, computing a two-dimensional projection of the geometric components, determining a position of each of the geometric components based on the two-dimensional projection of the geometric components, and placing each of the geometric components in the scatter plane based on the position of said each geometric component.

The method may include determining a position of a view point associated with the CAD model, determining a position of a viewing plane based on a current view of the CAD model, and determining a reference plane parallel to the viewing plane and passing through the determined view point. Further, the method may include computing a bounding box for each of the geometric components in the CAD model, determining at least one of the bounding boxes having at least one corner that is nearest to the reference plane, and determining a position of the scatter plane parallel to the reference plane and at a pre-determined distance from the at least one corner of the determined bounding box. In some embodiments, the scatter plane is determined such that the geometric components scattered in the scatter plane do not interfere with other geometric components in the three-dimensional space. The first geometric component of the geometric components is placed at the origin of the scatter plane. The method may also include determining the pre-determined distance from the at least one corner of the determined bounding box nearest to the reference plane.

In computing the two-dimensional projection of the geometric components, the method may include determining a trimetric view of the geometric components with pre-defined view angles, and computing a projection of the geometric components in the trimetric view on the viewing plane.

In another aspect, an apparatus may include a processing unit and a memory coupled to the processing unit. The memory includes a component scattering module configured for determining geometric components needed for assembling a Computer-Aided Design (CAD) model of a product, determining a scatter plane for scattering the geometric components in the three-dimensional space in the CAD environment, computing a two-dimensional projection of the geometric components, determining a position of each of the geometric components based on the two-dimensional representation of the geometric components, and placing each of the geometric components in the scatter plane based on the position of said each geometric component.

The component scattering module may be configured to determine a position of a view point associated with the CAD model, determine a position of a viewing plane based on a current view of the CAD model, and determine a reference plane parallel to the viewing plane and passing through the determined view point. Further, the component scattering module may be configured to compute a bounding box for each of the geometric components in the CAD model, determine at least one of the bounding boxes having at least one corner that is nearest to the reference plane, and determine a position of the scatter plane parallel to the reference plane and at a pre-determined distance from the at least one corner of the determined bounding box. The scatter plane is determined such that the geometric components scattered in the scatter plane do not interfere with other geometric components in the three-dimensional space. A first geometric component of the geometric components is placed at an origin of the scatter plane. The component scattering module may be configured to determine the pre-determined distance from the at least one corner of the determined bounding box nearest to the reference plane. The component scattering module may be configured to determine a trimetric view of the geometric components with pre-defined view angles, and compute the two dimensional projection of the geometric components in the trimetric view on the viewing plane.

In yet another aspect, a non-transitory computer-readable storage medium, having instruction stored therein, when executed by a processing unit, cause the processing unit to perform a method described above.

This summary is provided to introduce a selection of concepts in a simplified form that are further described below in the following description. The summary is not intended to identify features or essential features of the claimed subject matter. Further, the claimed subject matter is not limited to implementations that solve any or all disadvantages noted in any part of this disclosure.

### BRIEF DESCRIPTION OF THE DRAWINGS

A more complete appreciation of the present disclosure and many of the attendant aspects thereof will be readily obtained as the same becomes better understood by reference to the following description when considered in connection with the accompanying drawings:

FIG. 1 illustrates a block diagram of a data processing system in which an embodiment may be implemented, for example, as a Computer-Aided Design (CAD) system, particularly configured by software or otherwise to perform the processes as described herein;

FIG. 2 is a process flowchart illustrating an exemplary method of scattering geometric components in a three-dimensional space, according to one embodiment;

FIG. 3 illustrates a block diagram of a data processing system in which an embodiment may be implemented, according to another embodiment;

FIG. 4 illustrates a block diagram of a data processing system in which an embodiment may be implemented, according to yet another embodiment; and

FIG. 5 is a diagrammatic representation illustrating positioning of geometric components in a scatter box.

### DETAILED DESCRIPTION

A method and a system for scattering geometric components in a three-dimensional space are disclosed. Various embodiments are described with reference to the drawings, wherein like reference numerals are used to refer to like elements throughout. In the following description, numerous specific details are set forth in order to provide thorough understanding of embodiments of the present disclosure. It will be apparent to one skilled in the art that these specific details need not be employed to practice embodiments of the present disclosure. In other instances, well known materials or methods have not been described in detail in order to avoid unnecessarily obscuring embodiments of the present disclosure. While the disclosure is susceptible to various modifications and alternative forms, specific embodiments thereof are shown by way of example in the drawings and will herein be described in detail. It should be understood, however, that there is no intent to limit the disclosure to the particular forms disclosed, but on the contrary, the disclosure is to cover all modifications, equivalents, and alternatives falling within the spirit and scope of the present disclosure.

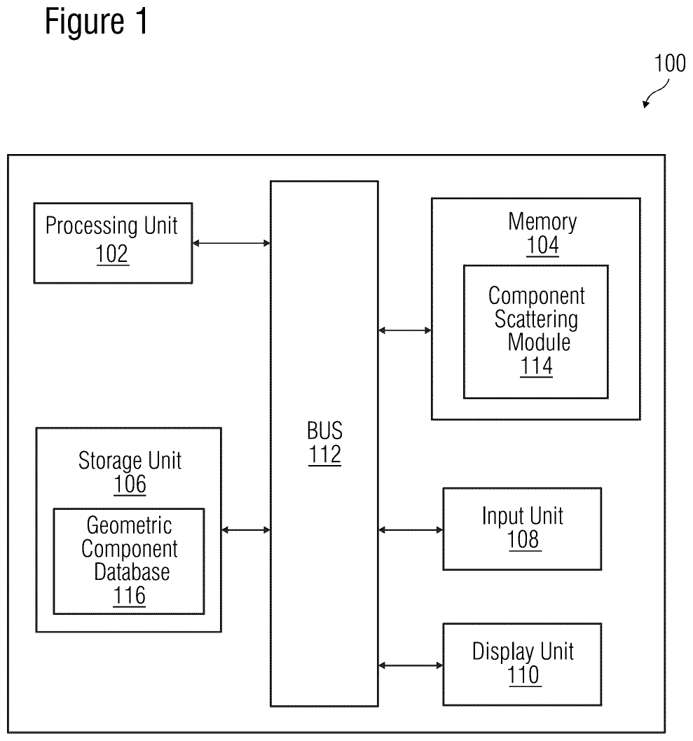

FIG. 1 illustrates a block diagram of a data processing system 100 in which an embodiment may be implemented, for example, as a Computer-Aided Design (CAD) system, particularly configured by software or otherwise to perform the processes as described herein.

The data processing system 100 may be a personal computer, a laptop computer, a tablet, and the like. In FIG. 1, the data processing system 100 includes a processing unit 102, an accessible memory 104, a storage unit 106, an input unit 108, a display unit 110, and a bus 112.

The processing unit 102, as used herein, may be any type of computational circuit, such as, but not limited to, a microprocessor, microcontroller, complex instruction set computing microprocessor, reduced instruction set computing microprocessor, very long instruction word microprocessor, explicitly parallel instruction computing microprocessor, graphics processor, digital signal processor, or any other type of processing circuit. The processing unit 102 may also include embedded controllers, such as generic or programmable logic devices or arrays, application specific integrated circuits, single-chip computers, and the like.

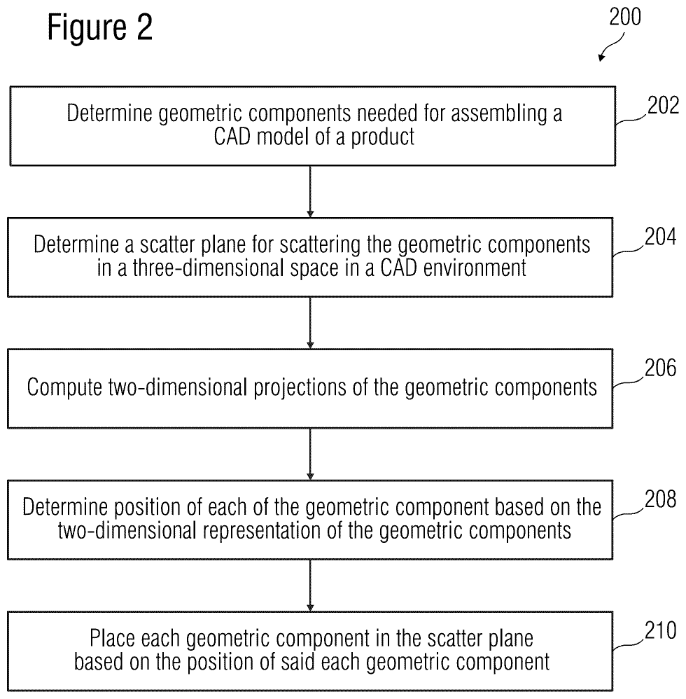

The memory 104 may be non-transitory volatile memory and non-volatile memory. The memory 104 may be coupled for communication with the processor 102, such as being a computer-readable storage medium. The processor 102 may execute instructions and/or code stored in the memory 104. A variety of computer-readable instructions may be stored in and accessed from the memory 104. The memory 104 may include any suitable elements for storing data and machine-readable instructions, such as read only memory, random access memory, erasable programmable read only memory, electrically erasable programmable read only memory, a hard drive, a removable media drive for handling compact disks, digital video disks, diskettes, magnetic tape cartridges, memory cards, and the like. In the present embodiment, the memory 104 includes a component scattering module 114 stored in the form of machine-readable instructions on any of the above-mentioned storage media and may be in communication to and executed by the processing unit 102. When executed by the processing unit 102, the component scattering module 114 causes the processing unit 102 to scatter geometric components of a product to be assembled in a three-dimensional space in a CAD environment. The component scattering module 114 is configured for determining geometric components needed for assembling a CAD model of a product. The component scattering module 114 is configured for determining a scatter plane for scattering the geometric components in the three-dimensional space in the CAD environment. The component scattering module 114 is configured for computing two-dimensional projection of the geometric components. The component scattering module 114 is configured for determining a position of each of the geometric components based on the two-dimensional representation of the geometric components. The component scattering module 114 is configured for placing each geometric component in the scatter plane based on the position of said each geometric component. Method acts performed by the processing unit 102 to achieve the above functionality are described in greater detail in FIG. 2.

The storage unit 106 may be a non-transitory storage medium that stores a component database 116. The component database 116 stores information associated with the geometric components of a product to be assembled in the CAD environment. The input unit 108 may include input devices such as keypad, touch-sensitive display, camera (e.g., a camera receiving gesture-based inputs), etc. capable of receiving input signals such as the information associated with one or more components to be classified. The display unit 110 may be a device with a graphical user interface displaying the geometric components of the product to be assembled. The graphical user interface may also display the geometric components scattered in a scatter plane. The bus 112 acts as interconnect between the processing unit 102, the memory 104, the storage unit 106, the input unit 108, and the display unit 110.

Those of ordinary skilled in the art will appreciate that the hardware depicted in FIG. 1 may vary for particular implementations. For example, other peripheral devices such as an optical disk drive and the like, Local Area Network (LAN)/ Wide Area Network (WAN)/ Wireless (e.g., Wi-Fi) adapter, graphics adapter, disk controller, input/output (I/O) adapter may also be used in addition to or in place of the hardware depicted. The depicted example is provided for the purpose of explanation only and is not meant to imply architectural limitations with respect to the present disclosure.

A data processing system 100 in accordance with an embodiment of the present disclosure includes an operating system employing a graphical user interface. The operating system permits multiple display windows to be presented in the graphical user interface simultaneously with each display window providing an interface to a different application or to a different instance of the same application. A cursor in the graphical user interface may be manipulated by a user through the pointing device. The position of the cursor may be changed and/or an event such as clicking a mouse button, generated to actuate a desired response.

One of various commercial operating systems, such as a version of Microsoft Windows™, a product of Microsoft Corporation located in Redmond, Washington may be employed if suitably modified. The operating system is modified or created in accordance with the present disclosure as described.

FIG. 2 is a process flowchart 200 illustrating an exemplary method of scattering geometric components in a three-dimensional space, according to one embodiment. At act 202, geometric components needed for assembling a CAD model of a product is determined. At act 204, a scatter plane for scattering the geometric components in the three-dimensional space in the CAD environment is determined. In one embodiment, position of a view point associated with the CAD model is determined. The position of view point is determined such that the view point is at the center of current graphics view and far away from existing geometric components towards outward normal direction of the current view plane. Position of a viewing plane is determined based on current view of the CAD model. For example, the current view of the CAD model is determined based on orientation of the three-dimensional space in the CAD environment. A viewing plane is a plane where a user is viewing a CAD model on the display unit 110. A reference plane parallel to the viewing plane and passing through the determined view point is determined. A bounding box for each of the geometric components in the CAD assembly is computed. At least one of the bounding boxes having at least one corner that is nearest to the reference plane is determined. Then, a pre-determined distance from the at least one corner of the determined bounding box nearest to the reference plane is determined. Position of the scatter plane is determined in such a manner that the scatter plane is parallel to the reference plane and at a pre-determined distance from the at least one corner of the determined bounding box is determined. In one or more of the present embodiments, the geometric components scattered in the scatter plane do not interfere with other geometric components in the three-dimensional space. The first geometric component of the geometric components is placed at the origin of the scatter plane.

At act 206, two-dimensional projections of the geometric components are computed. A trimetric view of the components with a pre-defined view angles is determined. The two-dimensional projection of the geometric components in the trimetric view on the viewing plane is computed. In one or more of the present embodiments, a trimetric view on the viewing plane provides a better view of the geometric component to the user. At act 208, position of each of the geometric component is determined based on the two-dimensional representation of the geometric components. In some embodiments, a scatter box is created in the scatter plane. In these embodiments, an occupied box enclosing the two-dimensional projection of each geometric component is created. A position box is created around the occupied box in such a manner that the boundaries of the position box is greater than the occupied box by a pre-defined margin. The pre-defined margin provides that there is sufficient space between the geometric components when scattered in the scatter plane. Origin and type of position box is calculated for each geometric component based on the boundaries of the scatter box and the previously placed position box. At act 210, each geometric component is placed in the scatter plane based on the position of said each geometric component. The geometric components are placed in the scatter plane by placing the position box of respective geometric components in the scatter box. The scatter box expands as and when a new position box is added to the scatter box.

In one embodiment, two position boxes corresponding to the selected geometric components having pre-defined origin and type are created. For example, a first position box is of type first quadrant, and a second position box is of type second quadrant. The origin of the first position box is same as the origin of the scatter box, and the origin of the second position box is top-right corner of the first position box.

The type and origin of next position box is determined based on the boundaries of the scatter box. It is determined whether there are any unoccupied boxes prior to creating the position box associated with the geometric component. In one example, an unoccupied box is a bounding box from which the geometric component was removed from the scattered geometric components. In another example, an unoccupied box is occupied by a smaller geometric component, and the unoccupied area has results in creation of one or more unoccupied boxes. In yet another example, an unoccupied box is created with a position box if there is free space is enclosed by other position boxes.

If there is no unoccupied box where the geometric component may be placed, then a new position box for the geometric component is created based on the determined origin and type. In one embodiment, if negative horizontal extent of the previous position box is less than that of the scatter box, then type of the position box is third quadrant and the origin of the position box is at an intersection of a bottom side of a previously placed position box and a left side of the scatter box. If a negative horizontal extent of the previously placed position box is greater than that of the scatter box, then the type of the position box is second quadrant and the origin of the position box is a bottom left corner of the previously placed position box. In another embodiment, if a negative vertical extent of the previously placed position box is less than that of the scatter box, then the type of the position box is fourth quadrant and the origin of the position box is at an intersection of a right side of the previously placed position box and a bottom side of the scatter box. If the negative vertical extent of the previously placed position box is greater than that of the scatter box, the type of the position box is third quadrant and the origin is a bottom right corner of the previously placed position box. In yet another embodiment, if a positive horizontal extent of the previously placed position box is greater than that of the scatter box, then the type of position box is first quadrant and the origin of the position box is at an intersection of a top side of the previously placed position box and a right side of the scatter box. If the positive horizontal extent of the previously placed position box is less than that of the scatter box, then the type of position box is fourth quadrant and the origin of the position box is a top right corner of the position box. In another embodiment, if the positive vertical extent of the previously placed position box is greater than that of scatter box, then the type of the position box is second quadrant and the origin of the position box is an intersection of a left side of the previously placed position box and a top side of the scatter box. If the positive vertical extent of the previously placed position box is less, then the type of position box is first quadrant and the origin is a top left corner of the previously placed position box.

Location of the position box in the three-dimensional space is determined using position of the scatter plane and position of the position box with respect to the scatter plane. The associated geometric component is placed at a desired scatter position in the scatter plane based on the position of the geometric component with respect to the origin of the position box and the location of the position box. The above acts are repeated until all the geometric components are scattered in the scatter plane.

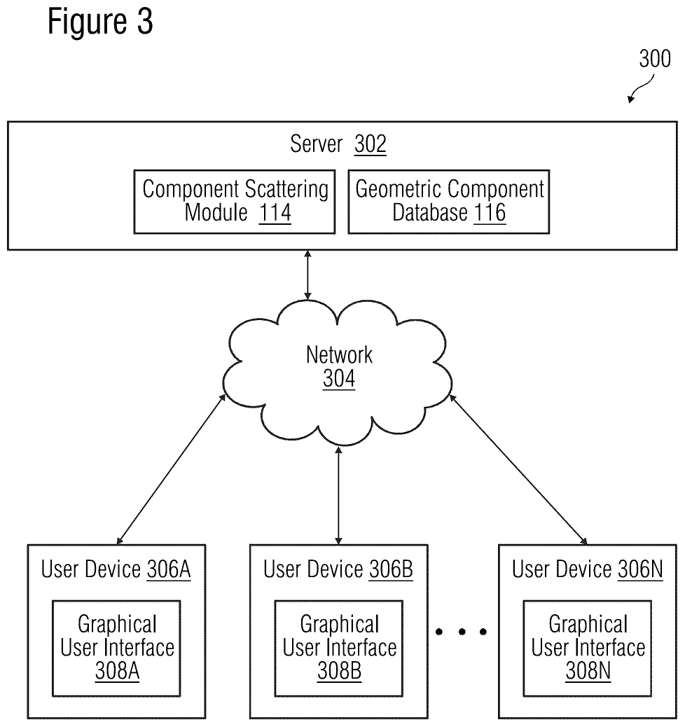

FIG. 3 illustrates a block diagram of one embodiment of a data processing system 300, in which an embodiment may be implemented. In one embodiment, the data processing system 300 includes a server 302 and a plurality of client devices 306A-N. Each client device of the plurality of client devices 306A-N is connected to the server 302 via a network 304 (e.g., Local Area Network (LAN), Wide Area Network (WAN), Wi-Fi, etc.). The data processing system 300 is another implementation of the data processing system 100 of FIG. 1, wherein the component scattering module 114 resides in the server 302 and is accessed by client devices 306A-N via the network 304.

The server 302 includes the component scattering module 114 and the component database 116. The server 302 may also include a processing unit, a memory, and a storage unit. The component scattering module 114 may be stored on the memory in the form of machine-readable instructions and executable by the processing unit. The component database 116 may be stored in the storage unit. The server 302 may also include a communication interface for enabling communication with client devices 306A-N via the network 304.

When the machine-readable instructions are executed, the component scattering module 114 causes the server 302 to scatter the geometric components associated with the product to be assembled in the three-dimensional space. Method acts performed by the server 302 to achieve the above-mentioned functionality are described in greater detail in FIG. 2.

The client devices 306A-N include graphical user interfaces 308A-N for managing information associated with the geometric components. Each of the client devices 306A-N may be provided with a communication interface for interfacing with the server 302. Users of the client devices 306A-N may access the server 302 via the graphical user interfaces 308A-N. For example, the users may send a request to the server 302 to scatter the geometric components along the scatter plane in the three-dimensional space. The graphical user interfaces 308A-N may be specifically configured for accessing the component scattering module 114 in the server 302.

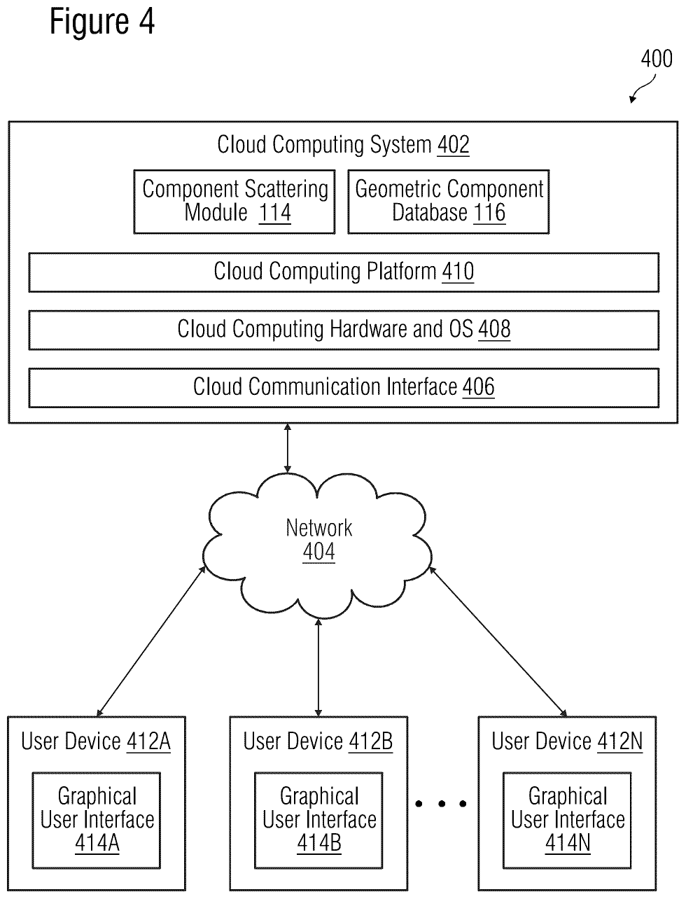

FIG. 4 illustrates a block diagram of one embodiment of a data processing system 400, in which an embodiment may be implemented. In one embodiment, the data processing system 400 includes a cloud computing system 402 configured for providing cloud services for designing and assembling geometric components.

The cloud computing system 402 includes a cloud communication interface 406, cloud computing hardware and OS 408, a cloud computing platform 410, the component scattering module 114, and the component database 116. The cloud communication interface 406 enables communication between the cloud computing platform 410, and user devices 412A-N such as smart phone, tablet, computer, etc. via a network 404.

The cloud computing hardware and OS 408 may include one or more servers on which an operating system (OS) is installed and includes one or more processing units, one or more storage devices for storing data, and other peripherals required for providing cloud computing functionality. The cloud computing platform 410 is a platform that implements functionalities such as data storage, data analysis, data visualization, data communication on the cloud hardware and OS 408 via APIs and algorithms, and delivers the aforementioned cloud services using cloud based applications (e.g., computer-aided design application). The cloud computing platform 410 employs the component scattering module 114 for scattering the geometric components associated with the product to be assembled in a scatter plane as described in FIG. 2. The cloud computing platform 410 also includes the component database 116 for storing information associated with the geometric components of the product to be assembled. The cloud computing platform 410 may include a combination of dedicated hardware and software built on top of the cloud hardware and OS 408.

In accordance with the foregoing embodiments, the cloud computing system 402 may enable users to scatter the geometric components in the scatter plane in such a manner that the geometric components do not interfere with other geometric components in the scatter plane. In one embodiment, the component scattering module 114 is configured for determining geometric components needed for assembling a CAD model of a product. The component scattering module 114 is configured for determining a scatter plane for scattering the geometric components in the three-dimensional space in the CAD environment. The component scattering module 114 is configured for computing two-dimensional projection of the geometric components. The component scattering module 114 is configured for determining a position of each of the geometric components based on the two-dimensional representation (e.g., projection) of the geometric components. The component scattering module 114 is configured for placing each geometric component in the scatter plane based on the position of said each geometric component.

The user devices 412A-N include graphical user interfaces 414A-N for receiving a selection of CAD commands and displaying geometric components. Each of the user devices 412A-N may be provided with a communication interface for interfacing with the cloud computing system 402. Users of the user devices 412A-N may access the cloud computing system 402 via the graphical user interfaces 414A-N. For example, the users may send a request to the cloud computing system 402 to scatter the geometric components in the scatter plane such that the geometric components do not interfere with other geometric components in the scatter plane. The graphical user interfaces 414A-N may be specifically designed for accessing the component scattering module 114 in the cloud computing system 402.

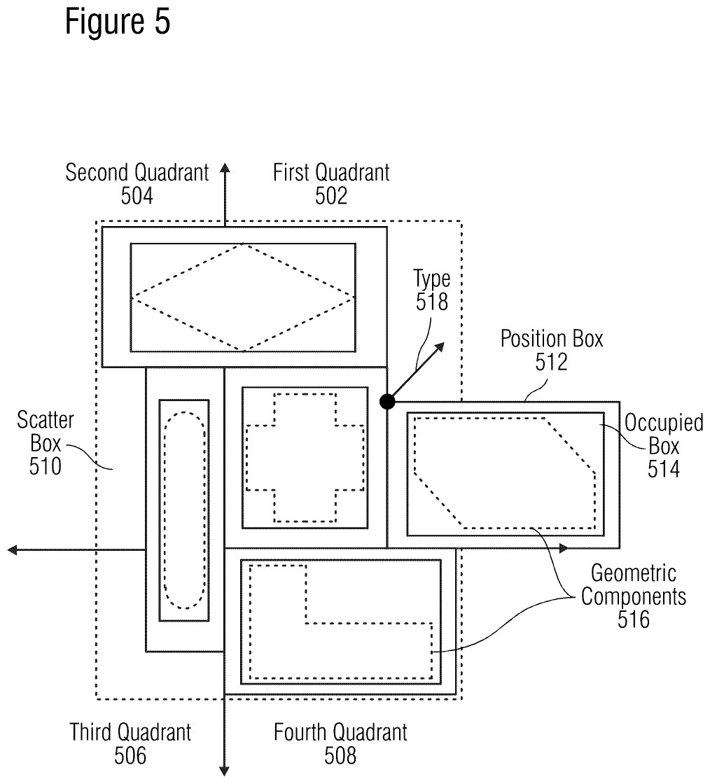

FIG. 5 is a diagrammatic representation illustrating positioning of placing of geometric components in a scatter box 510. FIG. 5 shows a scatter box 510 divided in four quadrants (e.g., a first quadrant 502, a second quadrant 504, a third quadrant 506, and a fourth quadrant 508). Inside the scatter box 510, one or more position boxes 512 are placed based on origin and type of the position boxes 512. Each position box 512 includes an occupied box 514. As shown, size of the position box is more than the occupied box 514 by a pre-defined gap. Each occupied box 514 includes the geometric component 516. In some embodiments, origin and type 518 of new position box 512 is determined based on position of previously placed position box 512. The type 518 may indicate direction in which the new position box 512 is to be placed with respect to the origin of the new position box 512. The direction of the type 518 indicates whether the position of the new position box 512 is in a first quadrant, a second quadrant, a third quadrant, or a fourth quadrant with respect to its own origin. The acts of determining origin and type of the new position box 512 are described in the foregoing description.

In the various embodiments described in FIGS. 1 to 4, the method and system consider sizes of all geometric components for scattering in a scatter plane, thereby making effective use of a three-dimensional space. Also, the method and system scatter geometric components away from existing geometric components in a scatter plane. This may help a user in ease of assembling the geometric components.

Those skilled in the art will recognize that, unless specifically indicated or required by the sequence of operations, certain acts in the processes described above may be omitted, performed concurrently or sequentially, or performed in a different order.

Those skilled in the art will recognize that, for simplicity and clarity, the full structure and operation of all data processing systems suitable for use with the present disclosure is not being depicted or described herein. Instead, only so much of a data processing system as is unique to the present disclosure or necessary for an understanding of the present disclosure is depicted and described. The remainder of the construction and operation of the data processing system may conform to any of the various current implementation and practices known in the art.

The system and methods described herein may be implemented in various forms of hardware, software, firmware, special purpose processors, or a combination thereof. One or more of the present embodiments may take a form of a computer program product including program modules accessible from a computer-usable or computer-readable medium storing program code for use by or in connection with one or more computers, processors, or instruction execution system. For the purpose of this description, a computer-usable or computer-readable medium may be any apparatus that may contain, store, communicate, propagate, or transport the program for use by or in connection with the instruction execution system, apparatus, or device. The medium may be electronic, magnetic, optical, electromagnetic, infrared, or a semiconductor system (or apparatus or device), or propagation mediums in and of themselves as signal carriers are not included in the definition of physical computer-readable medium, which includes a semiconductor or solid state memory, magnetic tape, a removable computer diskette, random access memory (RAM), a read only memory (ROM), a rigid magnetic disk and optical disk such as compact disk read-only memory (CD-ROM), compact disk read/write, and digital versatile disc (DVD). Both processors and program code for implementing each aspect of the technology may be centralized or distributed (or a combination thereof) as known to those skilled in the art.

While the present disclosure has been described in detail with reference to certain embodiments, it should be appreciated that the present disclosure is not limited to those embodiments. In view of the present disclosure, many modifications and variations would be present themselves, to those skilled in the art without departing from the scope of the various embodiments of the present disclosure, as described herein. The scope of the present disclosure is, therefore, indicated by the following claims rather than by the foregoing description. All changes, modifications, and variations coming within the meaning and range of equivalency of the claims are to be considered within their scope.

What is claimed is:

1. A method of scattering geometric components in a three-dimensional space in a Computer-Aided Design (CAD) environment, the method comprising:
determining geometric components needed for assembling a CAD model of a product;
determining a scatter plane for scattering the geometric components in the three-dimensional space in the CAD environment;
computing a two-dimensional projection of the geometric components;
determining a position of each of the geometric components based on the two-dimensional projection of the geometric components; and
placing each of the geometric components in the scatter plane based on the positions of the geometric components, respectively.

2. The method of claim 1, further comprising:
determining a position of a view point associated with the CAD model;
determining a position of a viewing plane based on a current view of the CAD model; and
determining a reference plane parallel to the viewing plane and passing through the determined view point.

3. The method of claim 2, wherein determining the scatter plane for scattering the geometric components in the three-dimensional space comprises:
computing a bounding box for each of the geometric components in the CAD model;
determining at least one of the bounding boxes having at least one corner that is nearest to the reference plane; and
determining a position of the scatter plane parallel to the reference plane and at a pre-determined distance from the at least one corner of the determined bounding box.

4. The method of claim 3, wherein the scatter plane is determined such that the geometric components scattered in the scatter plane do not interfere with other geometric components in the three-dimensional space.

5. The method of claim 3, further comprising determining the pre-determined distance from the at least one corner of the determined bounding box nearest to the reference plane.

6. The method of claim 1, wherein a first geometric component of the geometric components is placed at an origin of the scatter plane.

7. The method of claim 2, wherein computing the two-dimensional projection of the geometric components comprises:
determining a trimetric view of the geometric components with pre-defined view angles; and
computing the two-dimensional projection of the geometric components in the trimetric view on the viewing plane.

8. An apparatus comprising:
a processing unit; and
a memory coupled to the processing unit, wherein the memory comprises a component scattering module, wherein the component scattering module is configured, when executed by the processing unit, to:
determine geometric components needed for assembling a Computer-Aided Design (CAD) model of a product;
determine a scatter plane for scattering the geometric components in the three-dimensional space in the CAD environment;
compute a two-dimensional projection of the geometric components;
determine a position of each of the geometric components based on the two-dimensional projection of the geometric components; and
placing each of the geometric components in the scatter plane based on the positions of the geometric components, respectively.

9. The apparatus of claim 8, wherein the component scattering module is further configured, when executed by the processing unit, to:
determine a position of a view point associated with the CAD model;
determine a position of a viewing plane based on a current view of the CAD model; and
determine a reference plane parallel to the viewing plane and passing through the view point.

10. The apparatus of claim 9, wherein in the determination of the scatter plane for scattering the geometric components in the three-dimensional space, the component scattering module is further configured, when executed by the processing unit, to:
compute a bounding box for each of the geometric components in the CAD model;
determine at least one of the bounding boxes having at least one corner that is nearest to the reference plane; and
determine a position of the scatter plane parallel to the reference plane and at a pre-determined distance from the at least one corner of the determined bounding box.

11. The apparatus of claim 10, wherein the scatter plane is determined such that the geometric components scattered in the scatter plane do not interfere with other geometric components in the three-dimensional space.

12. The apparatus of claim 10, wherein the component scattering module is further configured, when executed by processing unit, to determine the pre-determined distance from the at least one corner of the determined bounding box nearest to the reference plane.

13. The apparatus of claim 8, wherein a first geometric component of the geometric components is placed at an origin of the scatter plane.

14. The apparatus of claim 9, wherein in the computation of the two-dimensional projection of the geometric components, the component scattering module is configured, when executed by the processing unit, to:
determine a trimetric view said the geometric components with pre-defined view angles; and
computing the projection of the geometric components in the trimetric view on the viewing plane.

15. A non-transitory computer-readable storage medium that stores instructions executable by a processing unit to scatter geometric components in a three-dimensional space in a Computer-Aided Design (CAD) environment, the instructions comprising:
determining geometric components needed for assembling a Computer-Aided Design (CAD) model of a product;
determining a scatter plane for scattering the geometric components in the three-dimensional space in the CAD environment;
computing a two-dimensional projection of the geometric components;
determining a position of each of the geometric components based on the two-dimensional projection of the geometric components; and
placing each of the geometric components in the scatter plane based on the positions of the geometric components, respectively.

16. The non-transitory computer-readable storage medium of claim 15, wherein the instructions further comprise:
determining a position of a view point associated with the CAD model;
determining a position of a viewing plane based on a current view of the CAD model; and
determining a reference plane parallel to the viewing plane and passing through the view point.

17. The non-transitory computer-readable storage medium of claim 16, wherein the instructions further comprise:
computing a bounding box for each of the geometric components in the CAD model;
determining at least one of the bounding boxes having at least one corner that is nearest to the reference plane; and
determining a position of the scatter plane parallel to the reference plane and at a pre-determined distance from the at least one corner of the determined bounding box.

18. The non-transitory computer-readable storage medium of claim 17, wherein the scatter plane is determined such that the geometric components scattered in the scatter plane do not interfere with other geometric components in the three-dimensional space.

19. The non-transitory computer-readable storage medium of claim 17, wherein the instructions cause the processing unit to perform a method step comprising determining the pre-determined distance from the at least one corner of the determined bounding box nearest to the reference plane.

20. The non-transitory computer-readable storage medium of claim 16, wherein the instructions further comprise:
determining a trimetric view of the geometric components with pre-defined view angles; and
computing the projection of the geometric components in the trimetric view on the viewing plane.
